(19) United States
(12) Patent Application Publication
(10) Pub. No.: US 2026/0249876 A1
(43) Pub. Date: Aug. 27, 2026

(54) VEHICLE

(71) Applicant: KAWASAKI MOTORS, LTD., Hyogo (JP)

(72) Inventors: Shohei TERAI, Hyogo (JP); Kouji ITO, Hyogo (JP); Osamu TANI, Hyogo (JP); Takenori SEGAWA, Hyogo (JP); Yoshiki HISAMOTO, Hyogo (JP)

(73) Assignee: KAWASAKI MOTORS, LTD., Hyogo (JP)

(21) Appl. No.: 19/541,433

(22) Filed: Feb. 17, 2026

Related U.S. Application Data
(60) Provisional application No. 63/761,319, filed on Feb. 21, 2025.

(51) Int. Cl. B60W 60/00

(52) U.S. Cl. CPC B60W 60/001; B60W 2520/10; B60W 2520/28; B60W 2552/15; B60W 2552/30; B60W 2552/35; B60W 2710/125; B60W 2710/20; B60W 2720/10

(57) ABSTRACT

A vehicle includes a traveling device that causes the vehicle to travel, and a controller. The controller causes the vehicle to travel autonomously, by outputting a travel command to the traveling device. The controller sets a turning radius of the vehicle, based on a drive state of the vehicle, the turning radius being included in the travel command.

### CROSS-REFERENCE TO RELATED APPLICATION

This application claims the benefit of U.S. Provisional Application No. 63/761,319 filed on Feb. 21, 2025, the entire contents of which are incorporated by reference herein.

### TECHNICAL FIELD

The present disclosure relates to a vehicle.

### BACKGROUND OF THE INVENTION

In JP 2020-013379 A, an operation system is disclosed of a self-driving vehicle that travels on a predetermined travel route based on a predetermined operation plan. In this system, the operation plan is re-constructed using information from a plurality of electric vehicles capable of automatic operation.

### SUMMARY OF THE INVENTION

According to a first aspect of the present disclosure, a vehicle is provided. The vehicle is an off-road vehicle capable of traveling over rough terrain. The vehicle includes a traveling device configured to cause the vehicle to travel, and a controller. The controller is configured to be able to cause the vehicle to travel autonomously, by outputting a travel command to the traveling device. The controller is configured to set a turning radius of the vehicle, based on a drive state of the vehicle, the turning radius being included in the travel command.

According to a second aspect of the present disclosure, a vehicle is provided. The vehicle is an off-road vehicle capable of traveling over rough terrain. The vehicle includes a traveling device configured to cause the vehicle to travel, and a controller. The controller is configured to be able to cause the vehicle to travel autonomously, by outputting a travel command to the traveling device. The controller is configured to limit a vehicle speed in accordance with an amount of curvature of a curve on a planned travel route of the vehicle.

### BRIEF DESCRIPTION OF DRAWINGS

FIG. 1 is a schematic configuration view of a vehicle.

FIG. 2 is a system configuration view of the vehicle.

FIG. 3 is a flowchart showing an example of route planning processing.

FIG. 4 is a flowchart showing an example of turning radius adjustment processing.

### DETAILED DESCRIPTION OF THE INVENTION

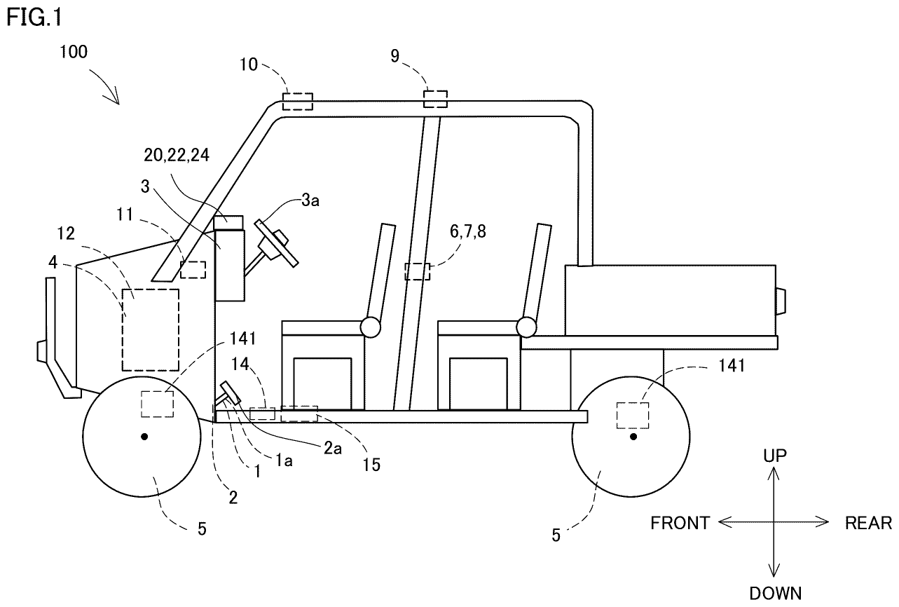

FIG. 1 is a schematic configuration view of a vehicle 100 according to an embodiment of the present disclosure. The vehicle 100 according to the present embodiment is an off-road vehicle that travels on rough terrain. The vehicle 100 is configured to be able to travel on ground that is not paved, such as earth, mud, rocks and the like in a desert or a forest, for example.

The vehicle 100 includes a rollover protective structure (ROPS) and a cargo bed. The vehicle 100 is a so-called self-driving vehicle that can plan a route from a departure location to a target location, and can travel autonomously along the planned route. The autonomous travel is also referred to as automatic operation. The vehicle 100 is capable of unmanned autonomous travel in which a driver is not on board, or manned autonomous travel in which the driver is on board. Note that, in the present disclosure, the driver may be appropriately referred to as an occupant.

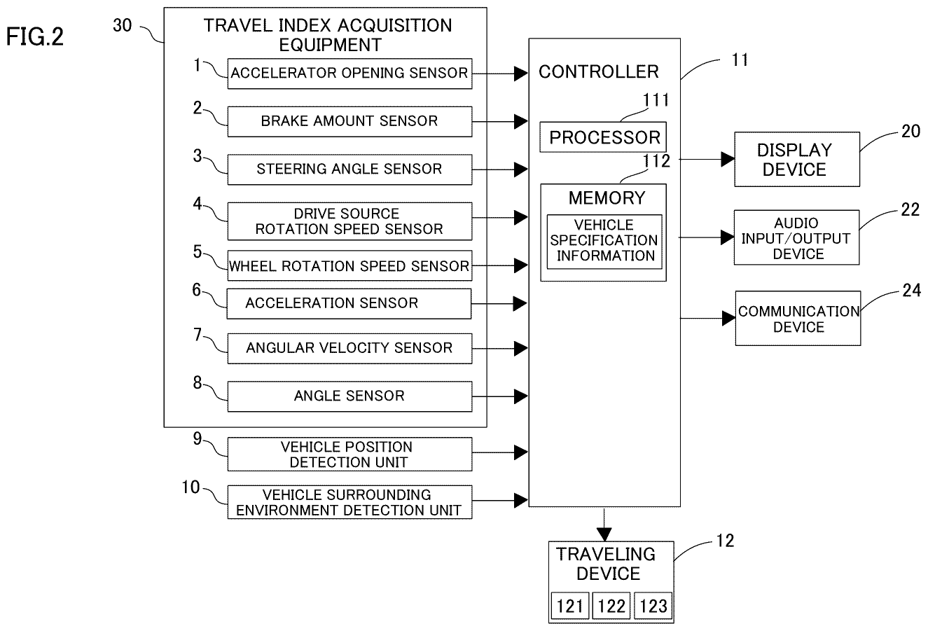

FIG. 2 is a schematic system configuration view of a vehicle. The vehicle 100 mainly includes a traveling device 12, travel index acquisition equipment 30, a vehicle position detection unit 9, a vehicle surrounding environment detection unit 10, a controller 11, a display device 20, an audio input/output device 22, and a communication device 24.

The traveling device 12 includes a drive device 121, a braking device 122, and a steering device 123. The drive device 121 is a device configured to output a drive force to be imparted to the vehicle 100, in order to cause the vehicle 100 to travel. The drive device 121 is, for example, an internal combustion engine, a motor, or the like. The braking device 122 is a device configured to output a braking force to be imparted to the vehicle 100, in order to brake the vehicle 100. The braking device 122 is a brake device, for example. The steering device 123 is a device configured to output a steering force to be imparted to the vehicle 100, in order to steer the vehicle 100. The steering device 123 is a steering mechanism, a steering unit, for example.

The vehicle 100 according to the present embodiment further includes a differential switching device 14, and a drive switching device 15. The differential switching device 14 controls a differential device of the front wheels and a differential device 141 of the rear wheels, and is configured to be able to switch a differential state of the front wheels and the rear wheels between a differential-free state and a differential-lock state. The drive switching device 15 is configured to be able to switch the drive state of the vehicle 100 between a two-wheel drive state in which only the left and right rear wheels are driven, and a four-wheel drive state in which the left and right front wheels and the left and right rear wheels are driven.

Note that, in FIG. 1 and the subsequent drawings, the vehicle 100 is exemplified by a configuration to which reference signs are allocated. Arrangements and sizes of each of the configurations (each of components) in the drawings do not represent actual arrangements and sizes.

As shown in FIG. 1, operation elements (operation devices) for operating the vehicle 100, such as a seat, an accelerator pedal 1a, a brake pedal 2a, a steering wheel 3a, and the like that are equipment for the driver, are installed in the vehicle 100. Note that when the autonomous travel is unmanned, this equipment for the driver need not necessarily be installed in the vehicle 100.

The travel index acquisition equipment 30 (travel-state detection unit) detects information indicating a travel state of the vehicle 100. As shown in FIG. 2, for example, the travel index acquisition equipment 30 includes an accelerator opening sensor 1, a brake amount sensor 2, a steering angle sensor 3, a drive source rotation speed sensor 4, a wheel rotation speed sensor 5, an acceleration sensor 6, an angular velocity sensor 7, and an angle sensor 8.

The accelerator opening sensor 1 detects an operation amount of the accelerator pedal 1a. The brake amount sensor 2 detects an operation amount of the brake pedal 2a. The steering angle sensor 3 detects an operation direction and an operation amount of the steering wheel 3a. During driving of the vehicle 100 by the driver, outputs from the drive device 121, the braking device 122, and the steering device 123 are performed in accordance with the operation amounts of the accelerator pedal 1a, the brake pedal 2a, the steering wheel 3a.

The drive source rotation speed sensor 4 detects a rotation speed of an output shaft of a drive source. The wheel rotation speed sensor 5 detects a rotation speed of a drive wheel. The wheel rotation speed sensor 5 may detect a rotation speed of a non-driven wheel. The acceleration sensor 6 is an inertial sensor, and detects an external force acting on the vehicle 100. The angular velocity sensor 7 detects a wheel angular velocity. The angle sensor 8 is a gyro sensor, and detects a posture of the vehicle 100. The vehicle 100 may further include various sensors, such as a stroke sensor provided on a suspension or the like. The posture of the vehicle 100 may be estimated from a degree of acceleration obtained by performing an arithmetic operation on an expansion/contraction amount of the stroke sensor provided on the suspension and a detection result of the stroke sensor.

The vehicle position detection unit 9 (the vehicle position detector) is configured to detect the position of the vehicle 100. The position of the vehicle 100 can also be said to be a vehicle position, or a self-position. In the present embodiment, the vehicle position detection unit 9 includes a global navigation satellite system (GNSS). The vehicle position detection unit 9 may output, as the vehicle position, a position obtained by performing an arithmetic operation on detection results of a wheel velocity sensor, an inertial sensor, and the like. In addition to or in place of the GNSS, the vehicle position detection unit 9 may acquire position information of the vehicle 100 from a ground base station, via the communication device 24.

The vehicle surrounding environment detection unit 10 detects a route on which the vehicle 100 is to travel, and a situation surrounding the vehicle 100. The vehicle surrounding environment detection unit 10 includes a camera, for example. In addition to the camera, the vehicle surrounding environment detection unit 10 may include a distance sensor that uses radar, laser, infrared, sound waves, or the like.

The vehicle surrounding environment detection unit 10 includes a sensor that is able to detect irregularities and an inclination (gradient, ups and downs) of a road surface. Of the irregularities of the road surface, the vehicle surrounding environment detection unit 10 is preferably configured to be able to detect a protrusion having a width smaller than a vehicle width of the vehicle 100, and a recession having a width smaller than the vehicle width of the vehicle 100. Of the irregularities of the road surface, the protrusion having the width smaller than the vehicle width of the vehicle 100 will also be referred to as a road surface protrusion. Of the irregularities of the road surface, the recession having the width smaller than the vehicle width of the vehicle 100 will also be referred to as a road surface recession. The road surface protrusion may be a fallen tree or a fallen rock, for example. The road surface recession may be a crevice, a ditch, or a rut, for example.

The vehicle surrounding environment detection unit 10 is configured to be able to determine whether or not a height of the road surface protrusion is higher than a ground clearance of the vehicle 100. The ground clearance is a height of a bottom surface of the vehicle 100 from a ground contact surface of the tires of the vehicle 100. The vehicle surrounding environment detection unit 10 is preferably configured to detect a road width of the road surface that can be traveled on. The recognition of the road surface protrusions and the road surface recession in the vehicle surrounding environment detection unit 10 may be realized by a learning arithmetic operation using image processing.

The communication device 24 communicates with the outside of the vehicle 100 via a public network or the like. The communication with the outside of the vehicle 100 includes a management center of the vehicle 100, or a server device provided at a position separated from the vehicle 100. The communication device 24 need not necessarily be installed in the vehicle 100. The communication device 24 may be provided in a mobile device, such as a smartphone or a tablet terminal carried by the driver. The controller 11 may communicate with the outside of the vehicle 100 via the mobile device.

The display device 20 is a display of an instrument panel or a navigation device, for example. The audio input/output device 22 is a microphone and a speaker. The vehicle 100 can perform notification of information, such as the travel state of the vehicle 100, a warning, or the like, via the display device 20 and the audio input/output device 22, or the like. The vehicle 100 is configured to be able to allow the driver to input information relating to route planning, such as the current position, the target location and the like, via the display device 20 and the audio input/output device 22, or the like.

The controller 11 includes a processor 111 and a memory 112. The controller 11 is configured to be able to transmit and receive signals with each of the components of the vehicle 100. The detection results of the travel index acquisition equipment 30, the vehicle position detection unit 9, and the vehicle surrounding environment detection unit 10 are input to the controller 11, for example. The controller 11 outputs various commands (signals), for causing the vehicle 100 to travel autonomously, to the drive device 121, the braking device 122, and the steering device 123 of the traveling device 12, and causes the vehicle 100 to travel autonomously by controlling the drive device 121, the braking device 122, and the steering device 123. The commands output to the traveling device 12 from the controller 11 will also be referred to as travel commands, or autonomous commands. Further, the controller 11 can acquire various information from the display device 20 and the audio input/output device 22, and can output various information to the display device 20 and the audio input/output device 22.

The controller 11 can execute various processing. For example, the controller 11 decides (generates) the travel plan of the vehicle 100. The controller 11 controls the traveling device 12 such that the vehicle 100 travels autonomously in accordance with the decided travel plan. The travel plan includes the route from a departure location (current position) to the target location, and travel conditions, such as the vehicle speed, a drive state, and the like of the vehicle 100. The travel plan will also be referred to as a route plan or the route planning.

The controller 11 can accelerate and decelerate the vehicle 100, can steer the vehicle 100, and can execute the switching of the drive state of the vehicle 100, and the like by controlling various units of the vehicle 100. The drive state of the vehicle 100 includes a state of transmitting a drive force to a drive wheel. The drive state includes, for example, a number of the drive wheels (two-wheel drive, four-wheel drive), and a engagement/disengagement of the differential lock. The differential lock includes a front wheel lock, and a rear wheel lock. Further, the switching of the drive state includes switching the vehicle 100 between two-wheel drive and four-wheel drive via the drive switching device 15, switching between the differential-free state and the differential-lock state via the differential switching device 14, changing a gear ratio, switching between a forward movement state and a reverse movement state, and the like. The differential-lock state will also be referred to as the differential lock being engaged, and the differential-free state will also be referred to as the differential lock being disengaged.

The controller 11 may decide (generate) the travel plan before the travel of the vehicle 100, may generate the travel plan during the travel of the vehicle 100, or may change the decided travel plan, as needed, during the travel of the vehicle 100. The changing of the travel plan may include traveling a detour route that makes a detour from the departure location to the target location, changing (suppressing) a decided travel speed, or the like.

Vehicle specification information that indicates the vehicle class or performance of the vehicle 100 is stored in advance in the memory 112. The vehicle specification information includes various information relating to the vehicle 100, such as a total length, a total width, a wheel diameter, a wheel base, and a designed minimum turning radius of the vehicle 100, and the like, for example.

Map information may be further stored in the memory 112. The map information may be acquired from outside via the communication device 24. The map information preferably includes information relating to the ups and downs and inclination of the road surface, and information that can be detected by the vehicle surrounding environment detection unit 10. The controller 11 may update the map information based on information and the like provided from a vehicle around the vehicle 100 and acquired by the communication device 24.

In the present embodiment, the vehicle specification information further includes an allowable turning radius corresponding to the drive state. For example, a correlation between the drive state, which includes the two-wheel drive, the four-wheel drive, the engagement/disengagement of the differential lock on the front wheels, and the engagement/disengagement of the differential lock on the rear wheels, and the allowable turning radius is stored in the memory 112. Note that the allowable turning radius is also a radius around which the vehicle 100 can turn in a stable manner in actual driving.

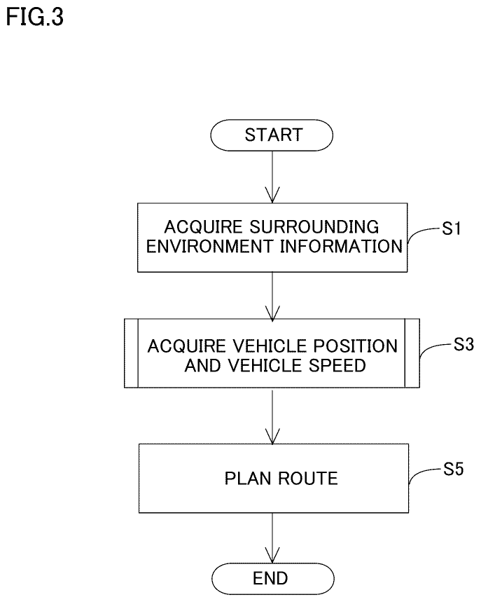

FIG. 3 is a flowchart showing an example of route planning processing executed by the processor 111 of the controller 11. For example, at a predetermined interval, the processor 111 of the controller 11 generates (decides) the route plan, which includes a departure position, the route from the current position to the target location, and the travel conditions such as the speed and drive state of the vehicle 100, and causes the vehicle 100 to travel autonomously based on the decided travel plan. Note that causing the vehicle 100 to travel autonomously based on the travel plan (the route) may mean causing the vehicle 100 to travel along the route, or may mean the processor 111 amending (correcting, changing) the route in the travel plan, in accordance with the road surface situation or the like.

At step S1, the processor 111 acquires surrounding environment information of the vehicle 100, via the vehicle surrounding environment detection unit 10.

At step S3, the processor 111 acquires the vehicle position and the vehicle speed.

At step S5, the controller 11 plans the travel route, which includes the route and the travel conditions, based on the information acquired at step S1 and step S3. The controller 11 controls the traveling device 12 such that the vehicle 100 travels autonomously in accordance with the plan.

In this way, the controller 11 outputs the various autonomous commands (travel commands) to the traveling device 12, so as to cause the vehicle 100 to travel along a planned travel route. The autonomous commands include commands relating to the turning radius of the vehicle 100. For example, the controller 11 outputs, to the steering device 123, a steering angle command in order to realize a turning radius in the travel plan. The autonomous command for realizing the turning radius may further include an output to the drive device 121 and the brake device 122.

As described above, the vehicle 100 according to the present embodiment includes the differential switching device 14 and the drive switching device 15 and the vehicle 100 can switch between the engagement/disengagement of the differential lock, and switch the drive wheels. Thus, it is conceivable that, depending on which of these drive states is applied to the vehicle 100, the possible turning radius of the vehicle 100 may be different. In this case, even when the vehicle 100 travels in accordance with the autonomous commands to the traveling device 12, there is a concern that the vehicle 100 may travel while deviating from the planned route. Taking this kind of situation into consideration, the controller 11 according to the present embodiment executes adjustment processing that adjusts the turning radius based on the drive state.

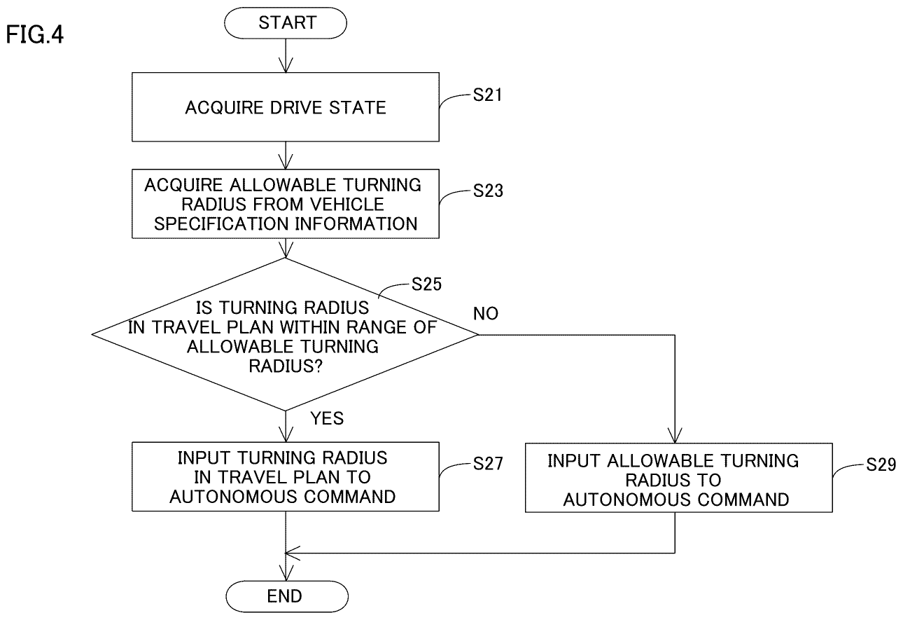

FIG. 4 is a flowchart showing an example of the adjustment processing. For example, this processing is executed in parallel with the above-described route planning processing.

At step S21, the processor 111 acquires the drive state, which is a power transmission state to the drive wheels of the vehicle 100. For example, the processor 111 acquires the engagement/disengagement of the differential lock for each of the front wheels and the rear wheels, via the differential switching device 14. Further, for example, the processor 111 acquires whether the vehicle 100 is in two-wheel drive or four-wheel drive via the drive switching device 15.

At step S23, the processor 111 reads out the vehicle specification information (the above-described correlation, for example) from the memory 112, and acquires the allowable turning radius corresponding to the drive state acquired at step S21.

At step S25, the processor 111 determines whether or not the turning radius in the travel plan determined at step S5 shown in FIG. 3 is within a range of the allowable turning radius acquired at step S23. When the planned turning radius is within the range of the allowable turning radius (yes at step S25), the processor 111 advances the processing to step S27.

At step S27, the processor 111 inputs the turning radius determined in the travel planning processing to the autonomous command. Inputting the turning radius to the autonomous command means using the autonomous command (travel command) relating to the turning radius determined in the travel planning processing as the command to be input to the traveling device 12.

On the other hand, when, at step S25, the turning radius in the plan is outside the range of the allowable turning radius (no at step S25), the processor 111 advances the processing to step S29.

At step S29, in place of the turning radius determined in the travel planning processing, the processor 111 inputs the allowable turning radius acquired at step S23 to the autonomous command. In this way, the autonomous command relating to the allowable turning radius is used as the command to be input to the traveling device 12, not the autonomous command (travel command) relating to the turning radius determined in the travel planning processing.

By executing the processing at step S27 or step S29, the vehicle 100 travels autonomously using the turning radius that accords with the drive state.

According to the adjustment processing as described above, the turning radius that accords with the drive state is input to the traveling device 12. Thus, the vehicle 100 can travel autonomously on the planned route, while turning appropriately in accordance with the drive state.

Further, a situation can be suppressed in which the vehicle 100 may travel while deviating from the planned route due to the turning radius in the route plan not corresponding to the allowable turning radius.

In the route planning processing and adjustment processing according to the above-described embodiment, and in the controller 11 that executes the processing and the vehicle 100 including the controller 11, the following modified examples are possible or the following aspects can be added.

The drive state acquired at step S21 of the adjustment processing may take into account the vehicle speed, a slip rate (slip ratio), a degree of inclination of the road surface, and a state of unevenness of the road surface, for example. For example, the processor 111 may correct the autonomous command relating to the turning radius at step S29, based on the vehicle speed, the slip rate, the degree of inclination of the road surface, the state of unevenness of the road surface, and the like. Note that, in the correction of the autonomous command, the processor 111 can acquire the vehicle speed, the slip rate, the degree of inclination of the road surface, the state of unevenness of the road surface and the like based on the signals output from the vehicle position detection unit 9, the vehicle surrounding environment detection unit 10, and the travel index acquisition equipment 30. The degree of inclination of the road surface, the state of unevenness of the road surface may be stored as map information in the memory 112. Further, the processor 111 may calculate the slip rate using the following Formula 1.

Slip rate={(vehicle speed)−(wheel angular velocity)×(wheel diameter)}/{(wheel angular velocity)×(wheel diameter)} Formula 1

The vehicle speed considered in the correction of the autonomous command may be the vehicle speed of the non-driven wheels (front wheels). In the acquisition of the vehicle speed, when the vehicle 100 is in four-wheel drive, for example, the processor 111 may temporarily switch the drive state of the vehicle 100 to the two-wheel drive state via the drive switching device 15, and may acquire the speed of the non-driven wheels based on the signal from the wheel rotation speed sensor 5 of the travel index acquisition equipment 30.

In the above-described adjustment processing, in addition to adjusting the turning radius, the processor 111 may further adjust the vehicle speed. For example, when, at step S25, the turning radius in the travel plan is outside the range of the allowable turning radius (no at step S25), at step S27, the processor 111 may input the allowable turning radius to the autonomous command and also execute vehicle speed limit processing that reduces the vehicle speed included in the travel conditions in the route plan. Reducing the vehicle speed also means limiting the vehicle speed. For example, the processor 111 may limit the vehicle speed, which is equal to or greater than a lowest speed and equal to or lower than a maximum speed allowed in the environment in which the vehicle 100 is traveling, to a speed that can suppress deviation of the vehicle 100 from the planned route.

Further, in the vehicle speed limit processing, the processor 111 may gradually reduce the vehicle speed over a predetermined time period (in stages) so as to reach a speed limit. When the vehicle speed has reached the speed limit, the processor 111 may cause the vehicle 100 to travel so as to maintain the speed limit.

In the vehicle speed limit processing, the processor 111 may limit the vehicle speed in accordance with a degree of curvature (amount of curvature) of a curve in the route determined in the travel plan. For example, the processor 111 may limit the vehicle speed such that the vehicle speed is reduced more the greater the amount of curvature.

The processor 111 may execute the vehicle speed limit processing in accordance with the amount of curvature even when the turning radius in the travel plan is within the range of the allowable turning radius (yes at step S25).

At step S29 in the above-described adjustment processing, the processor 111 may input, to the autonomous command, a maximum value in the range of the allowable turning radius. Alternatively, in place of the maximum value in the range of the allowable turning radius, the processor 111 may input, to the autonomous command, a turning radius that is obtained by taking into account a predetermined margin in the allowable turning radius.

A correspondence between each of structural elements (features) of the above-described embodiment and each of structural elements (features) of the present disclosure is as described below. Note that each of the structural elements of the embodiment are merely examples, and are not intended to limit each of the structural elements of the present disclosure. The vehicle 100 is an example of a “vehicle”. The controller 11 and the processor 111 are an example of a “controller”. The traveling device 12 is an example of a “traveling device”. The travel index acquisition equipment 30, the vehicle position detection unit 9, and the vehicle surrounding environment detection unit 10 are an example of a “detection unit”.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality. There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer readable storage medium, a computer program product, a memory device, a record medium such as a CD-ROM or DVD, and/or the memory of a FPGAs or ASICs.

The present disclosure is not limited to the above-described embodiment and modified examples, and can be realized by various other aspects insofar as these do not depart from the gist and scope thereof. For example, the present disclosure can be realized by the following aspects. Each of technical features in the above-described embodiment and modified examples corresponding to technical features of each of the aspects described below can be switched or combined, as appropriate, in order to solve some or all of the issues of the present disclosure, or to achieve some or all of the effects of the present disclosure. Further, insofar as these technical features are not described as essential in the present specification, they may be omitted as appropriate.

(1) According to a first aspect of the present disclosure, a vehicle is provided. The vehicle is an off-road vehicle capable of traveling over rough terrain. The vehicle includes a traveling device configured to cause the vehicle to travel, and a controller. The controller is configured to be able to cause the vehicle to travel autonomously, by outputting a travel command to the traveling device. The controller is configured to set a turning radius of the vehicle based on a drive state of the vehicle, the turning radius being included in the travel command.

According to this aspect, the turning radius in the travel command to the traveling device can be set to an appropriate turning radius in accordance with a travel state of the vehicle.

(2) In the above-described aspect, as the drive state, the controller may set the turning radius using at least one of a number of drive wheels in the vehicle, and an engagement/disengagement of a differential lock of the vehicle.

According to this aspect, the turning radius can be set in accordance with the drive state, namely, in accordance with two-wheel drive, four-wheel drive, a differential lock state, a differential-free state, or the like.

In this aspect, the vehicle may be a two-wheel drive vehicle, may be a four-wheel drive vehicle, or may be a vehicle capable of switching between the two-wheel drive and the four-wheel drive. The vehicle may be configured to be capable of switching a differential state of front wheels operably coupled to a differential device of the front wheels, between a state in which a differential lock is disengaged (the differential-free state) and a state in which the differential lock is engaged. When the vehicle is configured to be capable of switching between the two-wheel drive and the four-wheel drive, the vehicle may include a drive switching device that switches the vehicle between the two-wheel drive and the four-wheel drive.

(3) In the above-described aspect, the controller may set the turning radius based on a predetermined correlation between the drive state and an allowable turning radius of the vehicle.

According to this aspect, the turning radius that is allowable can be set in accordance with the drive state.

In this aspect, the controller may include a storage device storing the correlation. The vehicle may include a communication device, and may acquire the correlation via the communication device.

(4) In the above-described aspect, as the turning radius, the controller may set a maximum value of an allowable turning radius of the vehicle.

According to this aspect, deviation can be suppressed from the turning radius planned in autonomous travel.

(5) In the above-described aspect, the vehicle may include a detection unit configured to detect information of the vehicle. The controller may acquire a vehicle speed via the detection unit, and may set the turning radius based on the acquired vehicle speed.

According to this aspect, the appropriate turning radius can be set based on the vehicle speed.

In this aspect, the detection unit may include a sensor provided on the vehicle. Acquiring the vehicle speed based on a detection result of the detection unit may include the controller estimating the vehicle speed from the detection result of the detection unit.

(6) In the above-described aspect, the detection unit may detect a rotation speed of a non-driven wheel of the vehicle. The controller may set the turning radius using the rotation speed of the non-driven wheel as the vehicle speed.

According to this aspect, the turning radius can be set that takes into account the rotation speed of the non-driven wheel.

(7) In the above-described aspect, the vehicle may be configured to switch the drive state of the vehicle between two-wheel drive and four-wheel drive. When the drive state is the four-wheel drive, the controller may switch the drive state to the two-wheel drive and set the turning radius using the rotation speed of the non-driven wheel detected by the detection unit.

According to this aspect, the turning radius can be set that takes into account the rotation speed of the non-driven wheel.

(8) In the above-described aspect, the controller may plan a route to cause the vehicle to reach a predetermined target position, and may control the traveling device to cause the vehicle to travel autonomously along the route. The controller may set the turning radius based on a road surface state in the route to be traveled by the vehicle.

According to this aspect, the turning radius can be set that takes into account the road surface state in the route to be traveled by the vehicle.

In this aspect, the vehicle may include a detection unit that detects road surface information in a surrounding environment of the vehicle, which is the information of the vehicle. In addition to, or in place of the detection unit, the controller may include a storage unit that stores map information including the road surface information. The controller may set the turning radius based on the road surface information acquired from at least one of the detection unit and the storage unit.

The road surface state and the road surface information may include information relating to ups and downs and an inclination of the road surface.

In the above-described embodiment, the controller may set the turning radius based on at least one of a degree of inclination of a road surface and an unevenness of a road surface, as the road surface state.

According to this aspect, the turning radius can be set that takes into account at least one of the degree of inclination of the road surface and the unevenness of the road surface in the route to be traveled.

(10) In the above-described aspect, the controller may limit a vehicle speed in accordance with an amount of curvature of a curve in a route to be traveled by the vehicle.

According to this aspect, as well as setting the appropriate turning radius in accordance with the drive state, the vehicle speed can be limited in accordance with the amount of curvature of the curve.

In this aspect, the amount of curvature of the curve can be said to be a degree of curvature of the curve.

(11) In the above-described aspect, the greater the amount of curvature of the curve, the more the controller may reduce the vehicle speed.

According to this aspect, the vehicle can be caused to travel appropriately in accordance with a state (drive state) of the vehicle, since the vehicle speed is reduced more the greater the amount of curvature of the curve.

(12) According to a second aspect of the present disclosure, a vehicle is provided. The vehicle is an off-road vehicle capable of traveling over rough terrain. The vehicle includes a traveling device configured to cause the vehicle to travel, and a controller configured to be able to cause the vehicle to travel autonomously, by outputting a travel command to the traveling device. The controller limits a vehicle speed in accordance with an amount of curvature of a curve in a route to be traveled by the vehicle.

According to this aspect, the vehicle can be caused to travel at the appropriate vehicle speed in accordance with the amount of curvature of the curve in the route to be traveled.

What is claimed is:

1. A vehicle comprising:
a traveling device configured to cause the vehicle to travel; and
a controller configured to be able to cause the vehicle to travel autonomously, by outputting a travel command to the traveling device, wherein
the vehicle is an off-road vehicle capable of traveling over rough terrain, and
the controller sets a turning radius of the vehicle, based on a drive state of the vehicle, the turning radius being included in the travel command.

2. The vehicle according to claim 1, wherein
as the drive state, the controller sets the turning radius using at least one of a number of drive wheels in the vehicle, and an engagement/disengagement of a differential lock of the vehicle.

3. The vehicle according to claim 1, wherein
the controller sets the turning radius based on a predetermined correlation between the drive state and an allowable turning radius of the vehicle.

4. The vehicle according to claim 1, wherein
as the turning radius, the controller sets a maximum value of an allowable turning radius of the vehicle.

5. The vehicle according to claim 1, comprising:
a detection unit configured to detect information of the vehicle, wherein
the controller acquires a vehicle speed via the detection unit, and sets the turning radius based on the acquired vehicle speed.

6. The vehicle according to claim 5, wherein
the detection unit detects a rotation speed of a non-driven wheel of the vehicle, and
the controller sets the turning radius using the rotation speed of the non-driven wheel as the vehicle speed.

7. The vehicle according to claim 6, wherein
the vehicle is configured to be able to switch the drive state of the vehicle between two-wheel drive and four-wheel drive, and
when the drive state is the four-wheel drive, the controller switches the drive state to the two-wheel drive and sets the turning radius using the rotation speed of the non-driven wheel detected by the detection unit.

8. The vehicle according to claim 1, wherein
the controller plans a route to cause the vehicle to reach a predetermined target position, and controls the traveling device to cause the vehicle to travel autonomously along the route, and
the controller sets the turning radius based on a road surface state in the route to be traveled by the vehicle.

9. The vehicle according to claim 8, wherein
the controller sets the turning radius based on at least one of a degree of inclination of a road surface and an unevenness of a road surface, as the road surface state.

10. The vehicle according to claim 1, wherein
the controller limits a vehicle speed in accordance with an amount of curvature of curve in a route to be traveled by the vehicle.

11. The vehicle according to claim 10, wherein
the greater the amount of curvature of the curve, the more the controller reduces the vehicle speed.

12. A vehicle comprising:
a traveling device configured to cause the vehicle to travel; and
a controller configured to be able to cause the vehicle to travel autonomously, by outputting a travel command to the traveling device, wherein
the vehicle is an off-road vehicle capable of traveling over rough terrain, and
the controller limits a vehicle speed in accordance with an amount of curvature of curve in a route to be traveled by the vehicle.
